(19) United States
(12) Patent Application Publication
(10) Pub. No.: US 2023/0325014 A1
(43) Pub. Date: Oct. 12, 2023

(54) TRANSPARENT ELECTRODE LAMINATE AND TOUCH SENSOR INCLUDING SAME

(71) Applicant: DONGWOO FINE-CHEM CO., LTD., Iksan-si (KR)

(72) Inventors: Yu-Mi AHN, Iksan-si (KR); Seung-Kook KIM, Iksan-si (KR); Keun-Tae OH, Iksan-si (KR)

(21) Appl. No.: 18/023,843

(22) PCT Filed: Aug. 24, 2021
(86) PCT No.: PCT/KR2021/011266

§ 371 Date: Feb. 28, 2023

(30) Foreign Application Priority Data
Sep. 1, 2020 (KR) 10-2020-0111184

(51) Int. Cl. G06F 3/041; H01B 1/02; H01B 1/08

(52) U.S. Cl. CPC G06F 3/041; H01B 1/02; H01B 1/08

(57) ABSTRACT

The present disclosure relates to a transparent electrode laminate and a touch sensor including the same, the transparent electrode laminate comprising a first metal oxide layer, a metal layer, and a second metal oxide layer which are laminated in sequence, in which high transmittance is exhibited and excellent etching property is provided by controlling the contents of metal oxides and indium oxides (In₂O₃) contained in the first metal oxide layer and the second metal oxide layer.

### TECHNICAL FIELD

The present disclosure relates to a transparent electrode laminate and a touch sensor including the same.

### BACKGROUND ART

A transparent electrode having conductivity can be applied to various technical fields. For example, a conductive transparent electrode material is used as a core electrode material for functional thin films such as antistatic films and electromagnetic wave shields, flat panel displays, solar cells, touch panels, transparent transistors, flexible photoelectric devices, and transparent photoelectric devices.

One of the most widely used transparent electrode materials is indium-doped tin oxide (ITO). Although ITO has satisfactory transmittance and physical properties in the entire range of visible light, ITO has a problem in that it is difficult to apply in an environment where a low resistance of 20 Ω/□ or less is required because the sheet resistance is high at about 30 Ω/□.

Accordingly, recently, an OMO transparent electrode having an oxide/metal/oxide structure capable of providing high electrical conductivity and high visible light transmittance, for example, a transparent electrode having an ITO/metal/ITO structure is used.

Such an OMO transparent electrode forms a patterned transparent electrode obtained by forming a transparent conductive film having an OMO structure, that is, a transparent electrode laminate, on a substrate by a known coating method or deposition method, and forming a desired pattern through a photolithography process using a patterned mask. However, when ITO/metal/ITO is etched to form a transparent electrode pattern in a photolithography process, it is difficult to uniformly etch the three layers due to differences in thickness and etching rate of each layer.

On the other hand, Japanese Patent Application Laid-open Publication No. 2015-115180 mentions the problems of ITO/metal/ITO but only recognizes the problems of moisture resistance degradation and metal film corrosion.

Therefore, it is necessary to develop a transparent electrode having excellent etching properties while forming a transparent electrode having high transmittance and low sheet resistance.

### DISCLOSURE

### Technical Problem

An objective of the present disclosure is to provide a transparent electrode laminate exhibiting high transmittance and excellent etching property, and a touch sensor including the same.

### Technical Solution

In order to solve the above problems, an objective of the present disclosure is to provide a transparent electrode laminate formed by including sequentially laminated a first metal oxide layer, a metal layer, and a second metal oxide layer, in which the first metal oxide layer and the second metal oxide layer includes 10% to 40% by weight of metal oxide and 60% to 90% by weight of indium oxide (In₂O₃).

In addition, the present disclosure provides a touch sensor including the transparent electrode laminate.

### Advantageous Effects

The transparent electrode laminate, according to the present disclosure, may provide improved visibility by exhibiting high transmittance. In addition, the transparent electrode laminate of the present disclosure has excellent etching properties, and as the line width is finely formed when forming the transparent electrode pattern, the transparent electrode laminate may not only solve the demerits such as a decrease in transmittance and moire interference but also receive sensitive input of a user's input motion when applied to a touch sensor.

### DESCRIPTION OF DRAWINGS

FIG. 1 is a schematic cross-sectional view showing a transparent electrode laminate according to an embodiment of the present disclosure; and

FIG. 2 is a schematic cross-sectional view for explaining the etching properties of the transparent electrode laminate according to one embodiment of the present disclosure.

### BEST MODE

The present disclosure provides a transparent electrode laminate with high transmittance and excellent etching properties by adjusting the contents of metal oxide and indium oxide (In₂O₃) included in the first and second metal oxide layers and a touch sensor including the transparent electrode laminate that includes a first metal oxide layer, a metal oxide layer, and a second metal oxide layer sequentially laminated, and metal oxide and indium oxide (In₂O₃) contained in the first metal oxide layer and the second metal oxide layer.

Referring to the following drawings, embodiments of the present disclosure will be described in more detail. However, the following drawings attached to this specification illustrate preferred embodiments of the present invention and serve to further understand the technical idea of the present invention together with the contents of the above-described invention, so this disclosure should not be limited to the matters described in such drawings.

<Transparent Electrode Laminate>

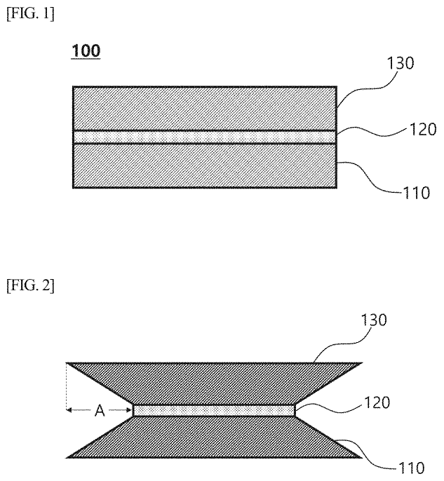

FIG. 1 is a schematic cross-sectional view showing a transparent electrode laminate according to an embodiment of the present disclosure, and FIG. 2 is a schematic cross-sectional view for explaining the etching properties of the transparent electrode laminate according to an embodiment of the present disclosure.

Referring to FIG. 1, the transparent electrode laminate 100 includes a first metal oxide layer 110, a metal layer 120, and a second metal oxide layer 130 sequentially laminated.

In this specification, the “transparent electrode” refers to an electrode including not only a transparent electrode but also an electrode that appears to be substantially transparent to a user by being manufactured with a narrow line width so as not to be identified by a user even if it is made of an opaque material.

The transparent electrode laminate is used as a transparent electrode having an OMO structure, including the first metal oxide layer 110, the metal layer 120, and the second metal oxide layer 130 sequentially laminated instead of the existing ITO transparent electrode, thereby remarkably improving visibility.

In one embodiment, the transparent electrode laminate 100 may be formed on a base layer (not shown).

The base layer may be used as a meaning encompassing a film-type substrate used as a base layer for forming the transparent electrode laminate 100 or an object on which the transparent electrode laminate 100 is formed. In some embodiments, the base layer may refer to a display panel on which a touch sensor is formed or laminated. Also, in some embodiments, the base layer may include a window substrate of an image display device.

For example, the base layer may be a substrate or film material commonly used in touch sensors without particular limitations. For example, it may include glass, polymer, and/or inorganic insulating material. The thickness of the substrate layer is not particularly limited and may be appropriately selected depending on the type of final product. For example, the base layer may have a thickness of 0.5 μm or more, 1 μm or more, or 10 μm or more, 20 μm or more, or 30 μm or more, but is not limited thereto. In addition, the substrate may have a thickness of 1 mm or less, for example, 500 μm or less, or 200 μm or less, but is not limited thereto.

The first metal oxide layer 110 may be formed on the base layer, and the second metal oxide layer 130 may be formed on the metal layer 120, but are not limited thereto. For example, a metal oxide layer may be formed by using metal organic chemical vapor deposition (MOCVD), chemical vapor deposition (CVD), plasma-enhanced chemical vapor deposition (PECVD), molecular beam epitaxy (MBE), hydride vapor phase epitaxy (HVPE), sputtering, or the like, but is not limited thereto.

If necessary, the transparent electrode laminate, according to the present disclosure, may further include an organic layer between the base layer and the first metal oxide layer.

The organic layer may be acrylic-based but is not limited thereto.

According to one embodiment of the present disclosure, either one of the first metal oxide layer 110 and the second metal oxide layer 130, preferably both, may be formed to include indium oxide, preferably may be formed to include indium zinc oxide (IZO). For example, the first metal oxide layer 110 and the second metal oxide layer 130 may be formed through a sputtering process using a target having a controlled content ratio of indium oxide (In₂O₃) and metal oxide.

In one embodiment, each of the first metal oxide layer 110 and the second metal oxide layer 130 may include 10% to 40% by weight of metal oxide and 60% to 90% by weight of indium oxide (In₂O₃). Preferably, 20% to 30% by weight of metal oxide and 70% to 80% by weight of indium oxide (In₂O₃) may be included.

In addition, in one embodiment, the first metal oxide layer 110 and the second metal oxide layer 130 of the present disclosure may not include TiO₂ and/or SnO₂ to prevent the over-etching of the metal layer from becoming more severe during batch etching by slowing the etching rate of the metal oxide.

In the transparent electrode laminate 100, according to the present disclosure, the first metal oxide layer 110 and the second metal oxide layer 130 include indium oxide (In₂O₃) and metal oxide adjusted to the above-described content range. Thus, a difference in the etching rate between the metal oxide layers 110 and 130 and the metal layer 120 may be reduced during an etching process for forming a transparent electrode pattern. Accordingly, when the transparent electrode laminate of the present disclosure is etched, the transparent electrode pattern may exhibit a uniform shape.

In the present disclosure, the transparent electrode laminate may include the metal oxide and the indium oxide (In₂O₃) in the above-described contents, thereby exhibiting high transmittance and excellent etching properties to manufacture a transparent electrode pattern to have a uniform and narrow line width.

For example, after the etching process, as shown in FIG. 1, a transparent electrode pattern in which both ends of the etched transparent electrode laminate are substantially straight, that is, in a state in which edges are aligned, may be formed.

Specifically, referring to FIG. 2, in the transparent electrode laminate 100, according to the present disclosure, the etching rate of the metal oxide layer can be controlled by mixing In₂O₃ and metal oxide in a specific content. Accordingly, the length A from the outermost end of one side surface of the metal layer etched through an etching process to the outermost end of one side surface of the first metal oxide layer may be reduced.

At this time, the length A may be 0 to 300 μm or less, preferably 0 to 200 μm or less, and most preferably 0 to 100 μm or less.

The transparent electrode stack 100, according to the present disclosure, can form a transparent electrode having a uniform shape and a fine pattern, thereby improving transmittance and treating the disadvantage of moire interference.

In the present disclosure, the metal oxide may be zinc oxide (ZnO).

Meanwhile, in the present disclosure, when the metal oxide content, for example, zinc oxide (ZnO) content is less than the above range, etching characteristics and transmittance may be reduced, and even when the zinc oxide (ZnO) content exceeds the above range, the transmittance may be reduced.

In the present disclosure, the metal layer 120 may play a role of realizing low resistance of the transparent electrode by virtue of excellent electrical conductivity and low resistivity.

In one embodiment, the metal layer 120 may include silver (Ag) or a silver (Ag) alloy.

The silver alloy may include silver alloy form containing silver as a main component and other metals such as Nd, Cu, Pd, Nb, Ni, Mo, Ni, Cr, Mg, W, Pa, In, Zn, Sn, Al, and Ti; and silver nitride, silver silicide, silver carbide, silver oxide, etc., but is not limited thereto.

For example, when an alloy of Ag/Palladium/Cu is used as the metal layer 120, the metal layer 120 has low sheet resistance and transparent characteristics when formed to be thin, and thus is suitable for an electronic device requiring both low resistance characteristics and high transmission characteristics.

In the present disclosure, the thickness of the first metal oxide layer 110, the metal layer 120, and the second metal oxide layer 130 is not particularly limited, for example, the thickness of the first metal oxide layer 110 and the second metal oxide layer 130 may independently be 10 to 60 nm, and the thickness of the metal layer 120 may be 3 to 20 nm in terms of ensuring high transmittance and low reflectivity and improving etching characteristics. More preferably, the thickness of the first metal oxide layer 110 and the second metal oxide layer 130 may be each independently 25 to 45 nm, and the thickness of the metal layer 120 may be 5 to 15 nm.

Specifically, in the transparent electrode laminate, according to one embodiment of the present specification, the metal layer may have a thickness of 7 nm or more and 20 nm or less.

When the thicknesses of the first metal oxide layer 110 and the second metal oxide layer 130 exceed the above range, the low resistance and high transmission characteristics of the metal oxide layers 110 and 130 may be reduced.

When the thickness of the metal layer 120 is within the above range, the transparent electrode has the advantage of having excellent electrical conductivity and a low resistance value. Specifically, when the thickness of the metal layer is less than the above range, it is difficult to form a continuous film, and thus it is difficult to obtain low resistance, and when the thickness of the metal layer is more than 20 nm, a transmittance of a transparent electrode decreases.

<Touch Sensor or Touch Screen Panel>

In addition, embodiments of the present disclosure provide a touch sensor or touch screen panel, including the above-described transparent electrode laminate.

In addition, embodiments of the present disclosure provide an image display device including the touch sensor, for example, an OLED device or an LCD device.

In the touch sensor including the transparent electrode laminate, according to the present disclosure, since the transparent electrode pattern is uniformly formed, the user's input operation can be sensitively received, and the image output from the display unit is clearly output. A touch sensor or touch screen panel including a transparent electrode laminate, according to the present disclosure, includes a series of contents described above for the transparent electrode laminate. In addition, the touch sensor or touch screen panel including the transparent electrode laminate, according to the present disclosure, may adopt a known touch sensor or touch screen panel configuration other than including the transparent electrode laminate of the present disclosure.

### Mode for Disclosure

Hereinafter, in order to aid understanding of the present disclosure, experimental examples, including specific examples and comparative examples, are presented, but these are only illustrative of the present disclosure and do not limit the scope of the appended claims. It is obvious to those skilled in the art that various changes and modifications to the embodiments are possible within the scope and spirit of the present disclosure, and it is natural that such changes and modifications fall within the scope of the appended claims. In addition, “%” and “part”, which represent content below, are based on weight unless otherwise indicated.

### EXAMPLES AND COMPARATIVE EXAMPLES

### Preparation of Transparent Electrode Laminate

### Example 1

In order to evaluate the optical properties, electrical properties and bending properties of the transparent electrode laminate of the present disclosure, a transparent electrode was prepared. The first metal oxide layer and the second metal oxide layer used a mixture of 80% by weight of indium oxide (In₂O₃) and 20% by weight of zinc oxide (ZnO), a silver-palladium-copper (APC) alloy (Ag: Pd:Cu=98:1:1% by weight) was used as the metal layer, a first metal oxide layer, a metal oxide layer, and a second metal oxide layer were sequentially laminated on a glass using sputtering, and then an electrode pattern was formed by etching and photolithography. Each layer had a thickness of 35 nm for the first metal oxide layer, 10 nm for the metal layer, and 35 nm for the second metal oxide layer.

### Examples 2 to 4 and Comparative Examples 1 to 2

The material of each layer is the same, but only the amount of indium oxide (In₂O₃) and zinc oxide (ZnO) included in the first metal oxide layer and the second metal oxide layer is changed according to Table 1 below. According to the method 1, the transparent electrode laminates of Examples 2 to 4 and Comparative Examples 1 to 2 were prepared.

TABLE 1

| Division | Composition of the first metal oxide layer | |
|---|---|---|
| (Unit: % by | and the second metal oxide layer | |
| weight) | ZnO | In₂O₃ |
| Example 1 | 20 | 80 |
| Example 2 | 30 | 70 |
| Example 3 | 40 | 60 |
| Example 4 | 10 | 90 |
| Comparative | 5 | 95 |
| Example 1 | | |
| Comparative | 45 | 55 |
| Example 2 | | |

### Experimental Example

1. Transmittance Measurement

The transmittance of the transparent electrode laminates prepared in Examples and Comparative Examples was measured with a spectrophotometer (CM-3600A, Konica Minolta) under a wavelength condition of 550 nm. The results are shown in Table 2 below.

2. Etching Property Evaluation

The etching properties of the transparent electrode laminates prepared in Examples and Comparative Examples, after the etching process was completed, the length A from the outermost end of one side of the metal layer to the outermost end of one side of the first metal oxide layer was measured by FIB-SEM, and the evaluation criteria are as follows. The etching property evaluation results are shown in Table 2 below.

<Evaluation Criteria>

⊚: 0 μm<A≤100 μm

∘: 100 μm<A≤200 μm

Δ: 200 μm<A≤300 μm

X: 300 μm<A

3. Visibility Evaluation

The visibility of the transparent electrode laminates prepared in Examples and Comparative Examples was visually measured based on pattern visibility after fine patterning. The results are shown in Table 2 below. On a scale of 10, the closer the score is to 10, the more difficult it is to visually recognize the pattern shape.

TABLE 2

| | | Etching | Visibility |
|---|---|---|---|
| Division | Transmittance | property | |
| Example 1 | 88.3% | ◯ | 8 |
| Example 2 | 89.0% | ⊚ | 9 |
| Example 3 | 88.4% | ⊚ | 8 |
| Example 4 | 87.8% | Δ | 7 |
| Comparative | 86.5% | X | 4 |
| Example 1 | | | |
| Comparative | 86.7% | ⊚ | 5 |
| Example 2 | | | |

Referring to Table 2, it was confirmed that the transparent electrode laminate according to the embodiment of the present disclosure exhibits excellent characteristics in transmittance, etching property, and visibility. On the other hand, the transparent electrode laminate according to the Comparative Example showed slightly lowered transmittance and visibility compared to the Example. In particular, in terms of etching property, it was confirmed that the metal layer was excessively over etched because the length A from the end of one side of the metal layer to the end of one side of the first metal oxide layer exceeded 300 μm.

### INDUSTRIAL APPLICABILITY

The transparent electrode laminate, according to the present disclosure, exhibits high transmittance, thereby improving visibility, and has excellent etching properties, so that when forming a transparent electrode pattern, a fine line width can be formed, thereby suppressing a decrease in transmittance and moire interference. Since the transparent electrode laminate can sensitively receive the user's input operation, there is industrial applicability.

1. A transparent electrode laminate comprising
a first metal oxide layer, a metal layer,
and a second metal oxide layer sequentially laminated, wherein the first metal oxide layer and the second metal oxide layer comprise 10% to 40% by weight of metal oxide and 60% to 90% by weight of indium oxide (In₂O₃).

2. The transparent electrode laminate of claim 1, wherein the metal layer comprises silver or a silver alloy.

3. The transparent electrode laminate of claim 1, wherein the first metal oxide layer and the second metal oxide layer each independently have a thickness in a range of 10 to 60 nm.

4. The transparent electrode laminate of claim 1, wherein the metal layer has a thickness of 3 to 20 nm.

5. The transparent electrode laminate of claim 1, wherein when a pattern is formed through etching, both ends of an etched transparent electrode laminate are substantially straight.

6. The transparent electrode laminate of claim 5, wherein a length A from an end of one side of an etched metal layer to an end of one side of the etched first metal oxide layer is in a range of 0 to 300 μm.

7. The transparent electrode laminate of claim 1, wherein the metal oxide is ZnO.

8. The transparent electrode laminate of claim 1, further comprising an organic layer.

9. A touch sensor comprising the transparent electrode laminate of claim 1.
